(19) United States
(12) Patent Application Publication
(10) Pub. No.: US 2025/0352016 A1
(43) Pub. Date: Nov. 20, 2025

(54) HOPPER INDICATOR

(71) Applicant: Nilfisk A/S, Copenhagen (DK)

(72) Inventor: John Helgeson, Shoreview, MN (US)

(21) Appl. No.: 18/665,192

(22) Filed: May 15, 2024

(51) Int. Cl. A47L 11/40; A47L 11/24; G01F 23/22

(52) U.S. Cl. CPC A47L 11/4008; A47L 11/24; A47L 11/4011; A47L 11/4013; G01F 23/22

(57) ABSTRACT

A cleaning machine includes a hopper, a cleaning element, and a hopper element system. The hopper defines an internal volume therewithin, and is disposed to collect debris collected by the cleaning machine during operation. The cleaning element is mounted to a portion of the cleaning machine and is disposed to pick up debris and deliver the debris to the hopper. The hopper indicator system is mounted to a portion of the hopper, and includes an arm disposed move relative to the hopper, and a sensor connected to the arm. The sensor is configured to sense when the arm comes into contact with debris in the hopper, and to determine a position of the arm relative to the hopper.

### BACKGROUND

The present disclosure generally relates to cleaning machines. In particular, the present disclosure relates to a hopper indicator system for a cleaning machine.

Existing cleaning machines often include debris hoppers that fill with debris as the cleaning machine operates. If the debris hopper becomes too full, the ability of the cleaning machine to pick up debris can be negatively impacted. Existing designs for cleaning machines can require manual inspection of the debris hopper by the operator. This requirement for manual inspection can result in the debris hopper going unchecked and can cause a decrease in cleaning performance which can lead to dirty floors after the cleaning machine has “cleaned.”

The inventors have recognized that there is a need for a more efficient and reliable way of checking a level of the debris in the debris hopper during operation of the cleaning machine.

### SUMMARY

This disclosure presents a cleaning machine with a hopper, a cleaning element, and a hopper element system. The hopper defines an internal volume therewithin, and is disposed to collect debris collected by the cleaning machine during operation. The cleaning element is mounted to a portion of the cleaning machine and is disposed to pick up debris and deliver the debris to the hopper. The hopper indicator system is mounted to a portion of the hopper, and includes an arm disposed move relative to the hopper, and a sensor connected to the arm. The sensor is configured to sense when the arm comes into contact with debris in the hopper, and to determine a position of the arm relative to the hopper.

This disclosure also presents a hopper indicator system for use in a hopper of a cleaning machine. This hopper indicator system includes an actuator, an arm operably coupled to the actuator, a sensor configured to detect when the arm comes into contact with debris, a controller, and a hopper indicator. The arm is disposed to rotate about a rotational axis of the actuator. The controller is communicatively coupled to and configured to receive signals from the sensor. The hopper indicator is also communicatively coupled with the sensor, and is configured to provide an indication to a user in response to the arm coming into contact with debris.

This disclosure additionally presents a method of detecting debris in a hopper of a cleaning machine. This method includes operating the cleaning machine, collecting debris with a cleaning element of the cleaning machine, delivering the debris into the hopper of the cleaning machine, detecting a level of the debris in the hopper with a hopper indicator system, and providing an indication of the level of the debris in the hopper. This hopper indicator system includes an actuator, an arm operably coupled to the actuator, and disposed to rotate about a rotational axis of the actuator, a sensor configured to detect when the arm comes into contact with the debris, a controller in configured to receive signals from the sensor, and a hopper indicator system configured to provide the indication to a user in response to the arm coming into contact with debris.

This disclosure further presents a method of determining a level of debris in a hopper of a cleaning machine by moving an arm of a hopper indicator system away from a sidewall of the hopper from a first position, contacting debris with the arm, creating a signal in response to the arm contacting the pile of debris, and indicating that the arm has come into contact with the pile of debris in response to the signal.

The present summary is provided only by way of example, and not limitation. Other aspects of the present disclosure will be appreciated in view of the entirety of the present disclosure, including the entire text, claims, and accompanying figures.

### BRIEF DESCRIPTION OF THE DRAWINGS

FIG. 1 shows a perspective view of a cleaning machine.

FIG. 2 shows an isolated perspective view of a hopper of the cleaning machine, with the hopper shown in phantom.

FIG. 3 shows an isolated perspective view of a first hopper indicator system with a first arm.

FIG. 4A shows a side view of the first arm in a first, starting position.

FIG. 4B shows a side view of the first arm in a second, contact position.

FIG. 4C shows a side view of the first arm in a third, reset position.

FIG. 5 shows a second hopper indicator system with a second arm.

FIG. 6 shows an isolated view of the second arm with a first base portion and a second distal portion.

FIG. 7A shows a side view of the second arm in a first, starting position according to a first embodiment.

FIG. 7B shows a side view of the second arm in a second, contact position according to a first embodiment.

FIG. 7C shows a side view of the second arm in a third, triggered position according to a first embodiment.

FIG. 7D shows a side view of the second arm in a fourth, contact position according to a first embodiment.

FIG. 7E shows a side view of the second arm in a fifth, reset position according to a first embodiment.

FIG. 8A shows a side view of the second arm in a first, starting position according to a second embodiment.

FIG. 8B shows a side view of the second arm in a second, contact position according to a second embodiment.

FIG. 8C shows a side view of the second arm in a third, triggered position according to a second embodiment.

FIG. 8D shows a side view of the second arm in a fourth, contact position according to a second embodiment.

FIG. 8E shows a side view of the second arm in a fifth, reset position according to a second embodiment.

While the above-identified figures set forth one or more embodiments of the present disclosure, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features and components not specifically shown in the drawings.

### DETAILED DESCRIPTION

The proposed disclosure presents a hopper indicator system designed for use in floor sweeper hoppers. In particular, this disclosure involves integrating a motor with a sensor (e.g., rotational encoder) within the hopper to detect the status of the debris. The hopper indicator uses a paddle, driven by an actuator (e.g., brushless DC motor), rotated towards the bottom of the hopper. Once the paddle comes into contact with debris, thereby detecting a level of the debris, the paddle then rotates back up to a reset position. The hopper indicator system can also provide feedback to the operator about the level of the debris in the hopper.

The embodiments disclosed herein enable proper emptying of the hopper at appropriate intervals before the hopper bin gets too full during cleaning operation(s). In this way, the cleaning functionality of the cleaning element can be maintained without debris causing a decrease in cleaning performance.

In this way, the embodiments of the present disclosure help to prevent the manual and timely checking of the hopper by the user thereby reducing the amount of time to operate the machine and provide the cleaning functionality of the cleaning operation. Additionally, with the bin being emptied before the hopper gets too full, a high level of cleaning can be maintained throughout the cleaning operation of the cleaning machine.

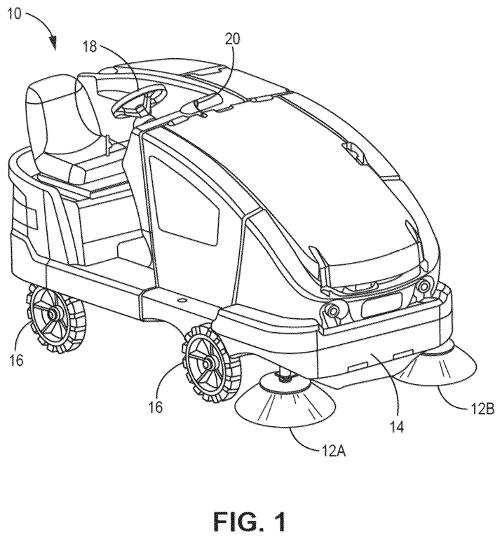

FIG. 1 shows a perspective view of cleaning machine 10 with first cleaning element 12A, second cleaning element 12B, hopper 14, wheels 16, steering component 18, and display 20.

In an embodiment, cleaning machine 10 is configured as a ride-on sweeper or sweeping machine. In another embodiment, cleaning machine 10 can be configured as at least one of a sweeper, a vacuum, a scrubber, or a combination thereof. In another embodiment, cleaning machine 10 can be configured as at least one of a walk behind machine, a ride-on machine, a partially autonomous machine, a fully autonomous machine, or a combination thereof.

First cleaning element 12A and second cleaning element 12B can be sweeper elements. In an embodiment, at least first cleaning element 12A, second cleaning element 12B, or a combination thereof can include a rotating or spinning sweeper element. In another embodiment, cleaning machine 10 can include a cylindrical brush sweeping element. Additionally, or alternatively, cleaning machine 10 can include a vacuum to drawn air, water, and particulate into cleaning machine (and distributed into a recovery tank which is not labeled in the figures).

Hopper 14 is a container for collecting debris collected by cleaning machine 10. For example, hopper 14 can define a cavity configured for receiving and collecting debris picked up from a cleaning surface by cleaning machine 10 (e.g., by way of first cleaning element 12A, second cleaning element 12B, or another component of cleaning machine 10). In an embodiment, hopper 14 can be configured for collection of at least one of dry debris, wet debris, or a combination thereof.

Wheels 16 are configured to at least one of steering, driving, or a combination thereof of cleaning machine 10. In an embodiment, there can be a single, centered wheel 16 at the back/rear of cleaning machine 10 rather than multiple rear wheels 16. Steering component 18 is a physical device for receiving steering and driving input from a user. For example, steering component 18 can include at least one of a wheel, a handle, a knob, or a combination thereof. Display 20 can be a screen or panel including one or more indicators for indicating information to a user. In an embodiment, display 20 can include at least one of a single indicator light, a lamp, a user interface, a tablet, or a combination thereof.

In an embodiment, display 20 can be separate from steering component 18. In another embodiment, display 20 can be combined with steering component 18. In another embodiment, at least one of steering component 18, display 20, or a combination thereof can be connected to and in communication with a controller (not shown in FIG. 1) of cleaning machine 10. As will be discussed below with respect to subsequent figures, display 20 can be in communication with a hopper indicator system of cleaning machine 10 and configured to display notifications from the hopper indicator system to a user.

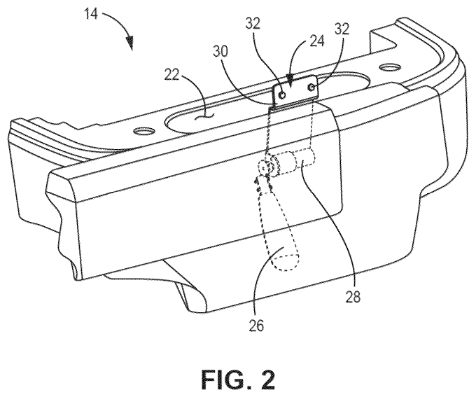

FIG. 2 shows an isolated perspective view of hopper 14 of the cleaning machine, with hopper 14 shown in phantom for clarity. Hopper 14 includes hopper indicator system 22 that is mounted to sidewall 24 of hopper 14. Hopper indicator system 22 can include first arm 26 and actuator 28. First arm 26 is a generally elongated piece of solid material. For example, first arm 26 can be a paddle. First arm 26 is operably coupled to a portion of actuator 28 and is disposed to rotate in response to movement applied by actuator 28.

Actuator 28 can be a motor. For example, actuator assembly 28 can be at least one of a direct current motor, an alternating current motor, or a combination thereof. In an embodiment, actuator 28 can be mounted to a portion of hopper 14. For example, actuator 28 can be mounted to sidewall 24 of hopper 14 with bracket 30 and fasteners 32. Actuator 28 is disposed to transfer motion to first arm 26. In an embodiment, actuator 28 is configured to cause first arm 26 to rotate about a rotational axis of actuator 28 such that first arm 26 moves relative to hopper 14 within internal volume 34 of hopper 14.

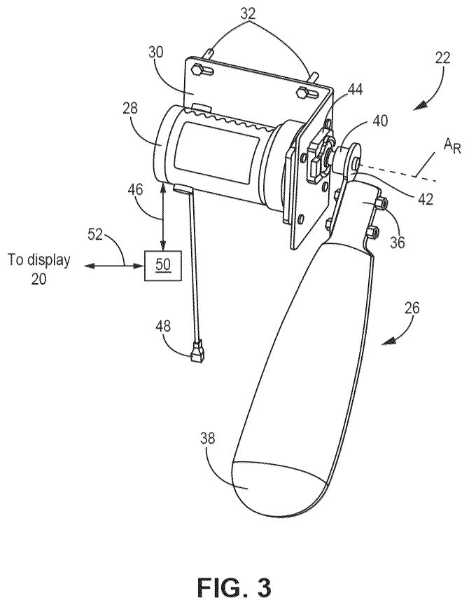

FIG. 3 shows an isolated perspective view of a portion of hopper indicator system 22 with first arm 26. FIG. 3 includes first arm 26 (with base 36 and tip 38), actuator 28 (with shaft 40 and blade 42), bracket 30, fasteners 32, sensor 44, wire 46, power interface 48, controller 50, and line 52. Hopper 14 is omitted from FIG. 3 for simplicity of explanation.

In an embodiment, first arm 26 includes a single elongated piece of solid material. The material can be suitable for contact with various types of debris, including rocks. This can include metallics and hardened polymer materials. Base 36 of first arm 26 is located on an end of first arm 26 proximal to actuator 28. Tip 38 of first arm 26 is located on the end of first arm 26 opposite base 36 and is distal to actuator 28. In an embodiment, actuator 28 is configured to move first arm 26 along an arcuate pathway. For example, actuator 28 is configured to convert electric current into driving rotation of shaft 40. Shaft 40 connects to and extends from actuator 28 to blade 42. Blade 42 is mounted to a distal end of shaft 40. Base 36 of first arm 26 is mounted to blade 42. As actuator 28 drives rotation of shaft 40, shaft 40 causes blade 42 to rotate about rotational axis A_{R}. Because base 36 of first arm 26 is mounted to blade 42, first arm 26 rotates or swings along an arcuate pathway as blade 42 rotates about rotational axis A_{R}. First arm 26 is disposed to move relative to hopper 14. Actuator 28 is configured to move first arm 26 along an arcuate pathway. Actuator 28 can be in communication with controller 50 via wired and/or wireless connection. In this embodiment, actuator 28 is connected to controller 50 via wire 46. In an alternative embodiment, sensor 44 can be connected to controller 50 via wire 46. Controller 50 is shown as a simplified block icon for clarity. Actuator 28 can further be in communication via power interface 48 which provides to actuator 28.

In an embodiment, sensor 44 is configured to sense an amount of rotation of at least shaft 40, blade 42, first arm 26, or a combination thereof. For example, sensor 44 can be a rotational encoder. Additionally or alternatively, sensor 44 can be configured to sense or detect at least one of when first arm 26 begins moving, stops moving, decreases a speed of rotation, increases a speed of rotation, comes into contact with debris, moved out of contact with debris, or a combination thereof. In another embodiment, sensor 44 can detect an amount of angular rotation of at least one of shaft 40, blade 42, first arm 26, or a combination thereof relative to at least one of bracket 30, hopper 14, or a combination thereof. In this embodiment, sensor 44 is shown as an external sensor, that is, not enclosed within a housing of actuator 28.

In an embodiment, sensor 44 includes a single sensor. In another embodiment, sensor 44 can include one or more sensors, with each sensor separably or combined to detect at least one of when first arm 26 begins moving, stops moving, decreases a speed of rotation, increases a speed of rotation, comes into contact with debris, moves out of contact with debris, or a combination thereof. Likewise, the one or more sensors of sensor 44 can detect, separably or in combination, an amount of angular rotation of at least one of shaft 40, blade 42, first arm 26, or a combination thereof relative to at least one of bracket 30, hopper 14, or a combination thereof.

In an embodiment, controller 48 can be a hub for placing components of cleaning machine 10 in communication with each other. For example, controller 48 can be configured to receive and provide communications between first cleaning element 12A, second cleaning element 12B, hopper 14, wheels 16, steering component 18, display 20, hopper indicator system 22, motor 38, sensor 44, or a combination thereof. Line 50 is a communication link between controller 48 and display 20 (not shown in FIG. 3) of cleaning machine 10. For example, communications can be passed between controller 48 and display 20 in both directions via line 50.

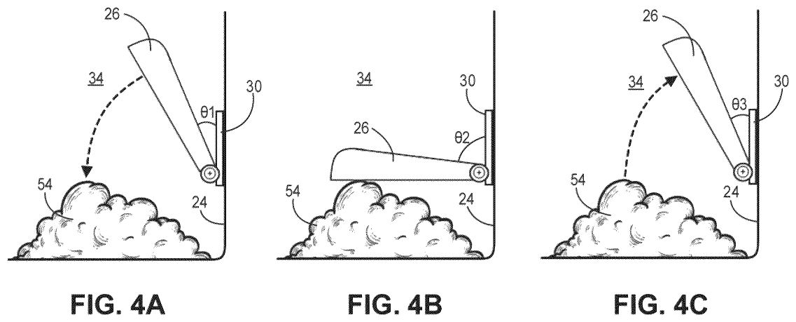

FIGS. 4A-4C illustrate various operational positions of first arm 26. More specifically, FIG. 4A shows a side view of first arm 26 in a first, starting position, FIG. 4B shows a side view of first arm 26 in a second, contact position, and FIG. 4C shows a side view of first arm 26 in a third, reset position. FIGS. 4A-4C are discussed together with continued reference to FIGS. 1-3.

In the starting position of FIG. 4A, first arm 26 can be angled with respect to bracket 30 and/or sidewall 24 of hopper 14 a first angle θ1. From the starting position, first arm 26 can then be rotated/lowered away from bracket 30/sidewall 24 toward debris 54, if present within internal volume 34 of hopper 14. Rotation of first arm 26 continues until it physically contacts debris 54 (i.e., reaches the contact position of FIG. 4B). Sensor 44 can sense the change in rotational speed caused as debris 54 resists and/or prevents further downward rotation of first arm 26 away from bracket 30/sidewall 24. At this time, actuator 28 can cease the downward rotation of first arm 26 while sensor 44 further senses the position of first arm 26, which can be angle θ2 in an embodiment, or some other representation of angular rotation. In general, angle θ2 can be greater than angle θ1. From the contact position, actuator 28 can reset the position of first arm 26 to the reset position illustration in FIG. 4C by rotating first arm 26 upward toward bracket 30/sidewall 24. In the reset position, the angle of first arm 26 with respect to bracket 30/sidewall 24 can be angle θ3, which can be substantially similar or identical to first angle θ1. The reset position can therefore be substantially similar or identical to the starting position.

This debris level detection executed by actuator 28 and first arm 26 can be programmed, for example, via controller 50, to occur at predetermined intervals. Such predetermined intervals can be, in one example, every several (e.g., five) minutes during operation of cleaning machine 10. Sensor 44 can output sensed data, such as change in speed and the associated angular position first arm 26 to controller 50. In turn, controller 50 can send to display 20 a debris level indication associated with the angular position of first arm 26 when it contacts debris 54. In an embodiment, debris level can be displayed as a percentage of a critical level, for example, with an “empty” hopper 14 reported at around 0% and a “full” hopper 14 reported at around 100%. In some cases, the operator of cleaning machine 10 may wish to or otherwise be required to empty hopper 14 prior to an indication of “full” (e.g., between 75% and 90%). In addition to a visual indication on display 20, controller 50 can cause an auditory indication (i.e., alarm) in some embodiments.

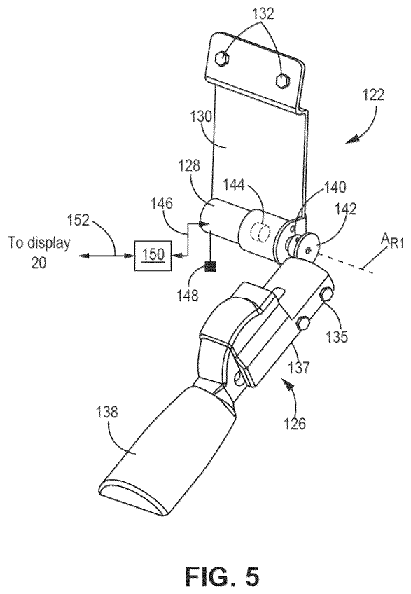

FIG. 5 shows alternative hopper indicator system 122 for hopper 14 of cleaning machine 10. Hopper indicator system 122 is substantially similar to hopper indicator system 22, having second arm 126 (with base 136, tip 138, and cover 137) rotatable about first axis A_{R1}, actuator 128 (with shaft 140 and blade 142), bracket 130, fasteners 132, sensor 144, wire 146, power interface 148, controller 150, and line 152. All components are configured in the same manner as the analogous components discussed above with respect to hopper indicator system 22, except that sensor 144 is internally positioned within actuator 128, and second arm 126 is hinged, as is discussed in greater detail below.

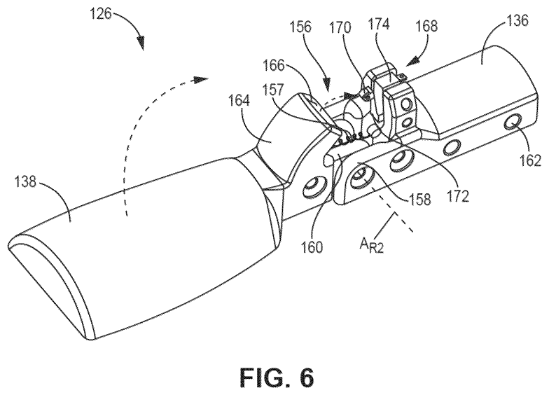

FIG. 6 shows second arm 126 isolated, for clarity, from the rest of hopper indicator system 122. Second arm 126 includes hinged joint 156 which permits tip 138 to rotate about second axis A_{R2} independently of and in relation to base 136. In this regard, tip 136 can be moved along an arcuate pathway. As used herein, tip 138 can refer to the entire portion of second arm 126 from hinged joint 156 to the distal edge of second arm 126, and base 136 can refer to the entire portion of second arm 126 from hinged joint 156 to the proximal edge of second arm 156, with respect to actuator 128. In an embodiment, hinged joint 156 can be formed by interlocking knuckles 158 and 160 of base 136 and tip 138, respectively, with a pin (not visible in FIG. 6). Spring element 157 can be disposed within hinged joint 156 for facilitating movement of tip 138 about hinged joint as is discussed in greater detail below. Visible in FIG. 6 are holes 162 within base 136 which can receive fasteners (not shown in FIG. 6) for attaching second arm 126 to blade 142. Second arm 126 further includes stopper 164 which helps limit the degree of rotation of tip 136 about second axis A_{R2}. More specifically, during rotation of tip 138, face 166 of stopper 164 is contactable against limit switch 168 which temporarily halts movement of second arm 126 as is discussed below in greater detail. In this embodiment, limit switch 168 can be a roller type limit switch with roller 170 mounted to lever 172 and attached to body 174. Cover 137 (shown and labeled in FIG. 5) can be used to protect the various moving components of and around hinged joint 156 and limit switch 168 from debris.

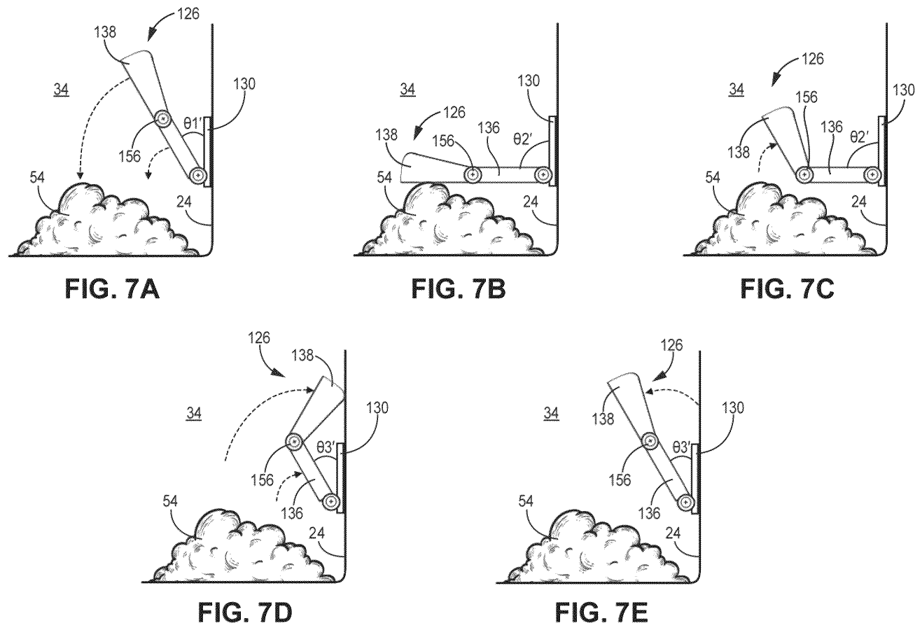

FIGS. 7A-7E illustrate various operational positions of second arm 126. More specifically, FIG. 7A shows a side view of second arm 126 in a first, starting position, FIG. 7B shows a side view of second arm 126 in a second, debris contact position, FIG. 7C shows a side view of second arm 126 in a third, triggered position, FIG. 7D shows a side view of second arm 126 in a fourth, hopper contact position, and FIG. 7E shows a side view of second arm 126 in a fifth, reset position. FIGS. 7A-7E are discussed together with continued reference to FIGS. 5 and 6.

In the starting position of FIG. 7A, second arm 126 can be angled with respect to bracket 130 and/or sidewall 24 of hopper 14 a first angle θ1′. From the starting position, second arm 126 can be rotated/lowered away from bracket 130/sidewall 24 toward debris 54, if present within internal volume 34 of hopper 14. As rotation of second arm 126 continues, contact with debris 54 (i.e., the debris contact position of FIG. 7B) causes tip 138 of second arm to rotate at hinged joint 156 away from debris 54 and toward base 136. Contact with debris 54 can cause spring element 157 to be released from an elongate (i.e., stretched) position to a compressed state in which it essentially pulls tip 138 toward limit switch 168. This can occur until face 166 of stopper 164 contacts roller 170 to a degree sufficient to trip limit switch 168 which halts downward rotation of second arm 126 by actuator 128 and triggers the upward rotation of second arm 126 toward bracket 130/sidewall 24. This is the triggered position illustrated in FIG. 7C. In the triggered position, sensor 144 can sense the position of second arm 126 which can be angle θ2′ in an embodiment, or some other representation of angular rotation. In general, angle θ2′ can be greater than angle θ1′. From the triggered position, actuator 128 rotate second arm 126 back toward sidewall 24 until it makes physical contact with sidewall 24 (i.e., the hopper contact position of FIG. 7D) which helps “straighten” second arm 126 by lengthening spring element 157 and moving stopper 166 back away from to limit switch 168 in order to achieve the reset position illustrated in FIG. 7D. In each of the hopper contact and reset positions, the angle of second arm 126 with respect to bracket 130/sidewall 24 can be angle θ3′, which can be substantially similar or identical to angle θ1′. The reset position can therefore be substantially similar or identical to the starting position.

Like first arm 26, the debris level detection executed by actuator 128 and second arm 126 can be programmed, for example, via controller 150, to occur at predetermined intervals, such as every several (e.g., five) minutes during operation of cleaning machine 10. Sensor 144 can output sensed data associated with the angular position of second arm 126 to controller 150. In turn, controller 150 can send to display 20 a debris level indication associated with such angular position of second arm 126 when it contacts debris 54. Debris level can be displayed as a percentage of a critical level, for example, with an “empty” hopper 14 reported at around 0% and a “full” hopper 14 reported at around 100%. Second arm 126 may be preferable as the sensed angular position of second arm 126 in the debris contact position can be captured with actuator halted due to the triggering of limit switch 168, rather than relying on a sensed change in speed to determine debris contact.

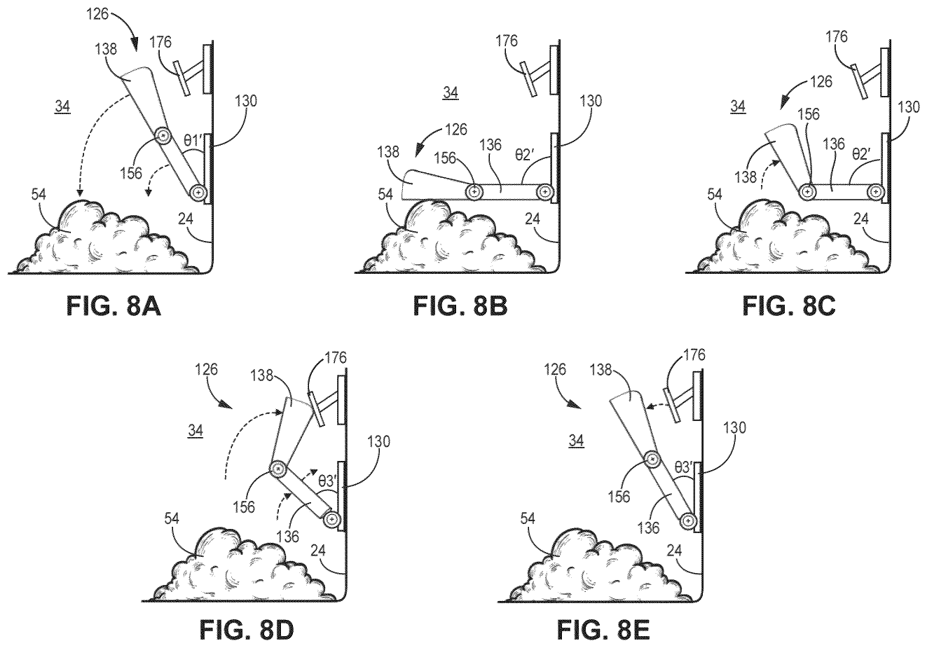

FIGS. 8A-8E illustrate various operational positions of second arm 126. More specifically, FIG. 8A shows a side view of second arm 126 in a first, starting position, FIG. 8B shows a side view of second arm 126 in a second, debris contact position, FIG. 8C shows a side view of second arm 126 in a third, triggered position, FIG. 8D shows a side view of second arm 126 in a fourth, hopper contact position, and FIG. 8E shows a side view of second arm 126 in a fifth, reset position. The operational positions shown in FIGS. 8A-8E are substantially similar to those shown in and discussed with respect to FIGS. 7A-7E above. The only difference is that in FIGS. 8A-8E, touch element 176 is attached to sidewall 24. Touch element 176 can be sized and positioned such that in the hopper contact position of FIG. 8D, instead of contacting sidewall 24, tip 138 of second arm 126 contacts touch element 176 in order to achieve the reset position of FIG. 8E. Touch element 176 can be any sort of suitable planar surface projecting from a bracket or formed integrally with sidewall 24. Touch element 176 can be used in a hopper 14 that, for example, does not have a suitable straight and/or planar sidewall 24 against which second arm 176 can be brought into contact to reset.

### Discussion of Possible Embodiments

The following are non-exclusive descriptions of possible embodiments of the present invention.

A cleaning machine comprising: a hopper defining an internal volume therewithin, wherein the hopper is disposed to collect debris collected by the cleaning machine during operation; a cleaning element mounted to a portion of the cleaning machine, wherein the cleaning element is disposed to pick up debris and deliver the debris to the hopper; and a hopper indicator system mounted to a portion of the hopper, the hopper indicator system comprising: an arm disposed to move relative to the hopper; and at least one sensor connected to the arm, wherein the at least one sensor configured to sense when the arm comes into contact with debris in the hopper, wherein the at least one sensor is configured to determine a position of the arm relative to the hopper.

The cleaning machine of the preceding paragraph can optionally include, additionally and/or alternatively, any one or more of the following features, configurations and/or additional components:

A further embodiment of the foregoing cleaning machine, further comprising: a controller in communication with the at least one sensor, the at least one sensor configured to sense when the arm comes into contact with debris inside of the hopper, and further to sense a position of the arm relative to the hopper.

A further embodiment of the foregoing cleaning machine, wherein the controller is configured to provide a notification in response to a signal received from the at least one sensor.

A further embodiment of the foregoing cleaning machine, wherein at least one sensor comprises a rotational encoder.

A further embodiment of the foregoing cleaning machine, further comprising an actuator, wherein the arm is mounted to the actuator, wherein the actuator is configured to move the arm along an arcuate pathway.

A further embodiment of the foregoing cleaning machine, wherein the arm is disposed to rotate relative to the hopper.

A further embodiment of the foregoing cleaning machine, wherein the arm comprises: a base portion; and an oppositely disposed tip portion connected to the base portion.

A further embodiment of the foregoing cleaning machine, further comprising: a hinged joint disposed between the tip portion and the base portion such that the tip portion is pivotable relative to the base portion; and a stopper element; and a limit switch contactable by the stopper element.

A hopper indicator system for use in a hopper of a cleaning machine, the hopper indicator system comprising: an actuator; an arm operably coupled to the actuator, wherein the arm is disposed to rotate about a rotational axis of the actuator; a sensor configured to detect when the arm comes into contact with debris; a controller in communication with the sensor, wherein the controller is configured to receive signals from the sensor; and a hopper indicator system in communication with the sensor, wherein the hopper indicator system is configured to provide an indication to a user in response to the arm coming into contact with debris.

The method of the preceding paragraph can optionally include, additionally and/or alternatively, any one or more of the following features, configurations and/or additional components:

The hopper indicator system of the preceding paragraph can optionally include, additionally and/or alternatively, any one or more of the following features, configurations and/or additional components:

A further embodiment of the foregoing hopper indicator system, wherein the sensor is configured to sense when the arm comes into contact with debris and further to sense a position of the arm relative to the actuator.

A further embodiment of the foregoing hopper indicator system, wherein the sensor comprises a rotational encoder.

A method of detecting debris in a hopper of a cleaning machine, the method comprising: operating the cleaning machine; collecting debris with a cleaning element of the cleaning machine; delivering the debris into the hopper of the cleaning machine; detecting a level of the debris in the hopper with a hopper indicator system, wherein the hopper indicator system comprises: an actuator; an arm operably coupled to the actuator, wherein the arm is disposed to rotate about a rotational axis of the actuator; a sensor configured to detect when the arm comes into contact with the debris; a controller in communication with the sensor, wherein the controller is configured to receive signals from the sensor; and a hopper indicator system in communication with the sensor, wherein the indicator system is configured to provide an indication to a user in response to the arm coming into contact with debris; and providing the indication of the level of the debris in the hopper.

A method of determining a level of debris in a hopper of a cleaning machine, the method comprising: moving an arm of a hopper indicator system away from a sidewall of the hopper from a first position; contacting debris with the arm; creating a signal in response to the arm contacting the pile of debris; and indicating that the arm has come into contact with the pile of debris in response to the signal.

The method of the preceding paragraph can optionally include, additionally and/or alternatively, any one or more of the following features, configurations and/or additional components:

A further embodiment of the foregoing method, further comprising returning the arm to the first position.

A further embodiment of the foregoing method, wherein upon contacting the debris, a tip portion of the arm rotates at a hinged joint toward a base portion of the arm until it trips a limit switch to temporarily halt movement of the arm.

A further embodiment of the foregoing method, further comprising: moving the arm back toward the sidewall of the hopper until the tip portion contacts the sidewall of the hopper which rotates the tip portion at the hinged joint away from the base portion; and returning the arm back to the first position.

A further embodiment of the foregoing method, wherein the arm is moveable from the first position at predetermined intervals.

The above detailed description includes references to the accompanying drawings, which form a part of the detailed description. The drawings show, by way of illustration, specific embodiments in which the disclosure can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the disclosure should be determined with reference to the appended claims, along with the full scope of equivalents to which such claims are entitled.

1. A cleaning machine comprising:
a hopper defining an internal volume therewithin, wherein the hopper is disposed to collect debris collected by the cleaning machine during operation;
a cleaning element mounted to a portion of the cleaning machine, wherein the cleaning element is disposed to pick up debris and deliver the debris to the hopper; and
a hopper indicator system mounted to a portion of the hopper, the hopper indicator system comprising:
an arm disposed to move relative to the hopper; and
at least one sensor connected to the arm, wherein the at least one sensor configured to sense when the arm comes into contact with debris in the hopper, wherein the at least one sensor is configured to determine a position of the arm relative to the hopper.

2. The cleaning machine of claim 1, further comprising: a controller in communication with the at least one sensor, the at least one sensor configured to sense when the arm comes into contact with debris inside of the hopper, and further to sense a position of the arm relative to the hopper.

3. The cleaning machine of claim 2, wherein at least one sensor comprises a rotational encoder.

4. The cleaning machine of claim 3, wherein the controller is configured to provide a notification in response to a signal received from the at least one sensor.

5. The cleaning machine of claim 1, and further comprising an actuator, wherein the arm is mounted to the actuator, wherein the actuator is configured to move the arm along an arcuate pathway.

6. The cleaning machine of claim 1, wherein the arm is disposed to rotate relative to the hopper.

7. The cleaning machine of claim 1, wherein the arm comprises:
a base portion; and
an oppositely disposed tip portion connected to the base portion.

8. The cleaning machine of claim 7, and further comprising:
a hinged joint disposed between the tip portion and the base portion such that the tip portion is pivotable relative to the base portion; and
a stopper element;
and a limit switch contactable by the stopper element.

9. A hopper indicator system for use in a hopper of a cleaning machine, the hopper indicator system comprising:
an actuator;
an arm operably coupled to the actuator, wherein the arm is disposed to rotate about a rotational axis of the actuator;
a sensor configured to detect when the arm comes into contact with debris;
a controller in communication with the sensor, wherein the controller is configured to receive signals from the sensor; and
a hopper indicator in communication with the sensor, wherein the hopper indicator is configured to provide an indication to a user in response to the arm coming into contact with debris.

10. The cleaning machine of claim 9, wherein the sensor is configured to sense when the arm comes into contact with debris and further to sense a position of the arm relative to the actuator.

11. The cleaning machine of claim 10, wherein the sensor comprises a rotational encoder.

12. A method of detecting debris in a hopper of a cleaning machine, the method comprising:
operating the cleaning machine;
collecting debris with a cleaning element of the cleaning machine;
delivering the debris into the hopper of the cleaning machine;
detecting a level of the debris in the hopper with a hopper indicator system, wherein
the hopper indicator system comprises:
an actuator;
an arm operably coupled to the actuator, wherein the arm is disposed to rotate about a rotational axis of the actuator;
a sensor configured to detect when the arm comes into contact with the debris;
a controller in communication with the sensor, wherein the controller is configured to receive signals from the sensor; and
a hopper indicator system in communication with the sensor, wherein the indicator system is configured to provide an indication to a user in response to the arm coming into contact with debris; and
providing the indication of the level of the debris in the hopper.

13. A method of determining a level of debris in a hopper of a cleaning machine, the method comprising:
moving an arm of a hopper indicator system away from a sidewall of the hopper from a first position;
contacting debris with the arm;
creating a signal in response to the arm contacting the pile of debris; and
indicating that the arm has come into contact with the pile of debris in response to the signal.

14. The method of claim 13, further comprising returning the arm to the first position.

15. The method of claim 13, wherein upon contacting the debris, a tip portion of the arm rotates at a hinged joint toward a base portion of the arm until it trips a limit switch to temporarily halt movement of the arm.

16. The method of claim 15, further comprising:
moving the arm back toward the sidewall of the hopper until the tip portion contacts the sidewall of the hopper which rotates the tip portion at the hinged joint away from the base portion; and
returning the arm back to the first position.

17. The method of claim 16, wherein the arm is moveable from the first position at predetermined intervals.
